(19) United States
(12) Patent Application Publication
(10) Pub. No.: US 2003/0231874 A1
(43) Pub. Date: Dec. 18, 2003

(54) Method for displaying additional information corresponding to a selected subtitle word displayed by a digital versatile disc system and apparatus therefrom

(76) Inventors: Chul Hur, Bloomfield Hills, MI (US); Soo I. Pyun, Seoul (KR)

Correspondence Address: Joseph W. Berenato, III, Liniak, Berenato, Longacre & White, LLC, Ste. 240, 6550 Rock Spring Drive, Bethesda, MD, 20817, US

(21) Appl. No.: 10/167,591

(22) Filed: Jun. 13, 2002

(51) Int. Cl. H04N 5/781

(52) U.S. Cl. 386/125; 386/126

(57) ABSTRACT

The claimed invention relates to a method of selecting a subtitle word displayed on a display by a digital versatile disc (DVD) system and thereafter displaying additional information corresponding to the selected subtitle word on a display. The method comprising the following steps: displaying subtitle data from a DVD on a display; selecting a subtitle data to be examined; converting the selected subtitle data into recognizable images; retrieving predetermined information related to the recognizable images; and displaying the predetermined information on the display. Operation of the DVD may thereafter be resumed. According to a first embodiment of the present invention, the DVD system is provided having an electronic dictionary function. The predetermined information is word definitions corresponding to words displayed in subtitles on the display. A user may select an unknown word, after which the definition of the unknown word is displayed on the display.

### FIELD OF THE INVENTION

The present invention relates to a method of selecting subtitle data displayed on a display by a digital versatile disc (DVD) system, and thereafter retrieving and displaying additional predetermined information corresponding to the selected subtitle data. Thus, a user may select a subtitle word appearing on the display, and the DVD system thereafter displays additional information based on the user's selection. In a first embodiment of the invention, a DVD system includes an electronic dictionary function. A user selects a subtitle word displayed on the display. Thereafter, a definition of the selected word is displayed on the display.

### DESCRIPTION OF THE PRIOR ART

A conventional DVD system is operable to access and receive information stored upon a laser-readable disc of storage media (DVD disc). The DVD disc stores compressed video, audio, and subtitle data. This data is stored on the DVD disc in accordance with a standardized format. The DVD system reads the data from the DVD disc, and stores the data in a buffer memory for subsequent retrieval. In addition, the DVD system can perform interactive playback in which a user can communicate with the system during playback, and provide additional instructions.

Subtitle data, called sub picture units (SPU), is actually displayed in the format of a graphic image, not as text data. SPU data can comprise a word, words or sentences, referred to as an ‘SPU packet’. When the DVD disc is produced, instead of imprinting a letter or word in a text format, subtitle images are comprised of the same data as other visual images on the disc. SPU data is therefore ‘burned’ as a graphic image onto the DVD disc at the appropriate place, so that it is synchronized with the audio being spoken and images displayed. Therefore, if a stream of video images are displayed on the display, there are pre-designated places for locating SPU data.

As best shown in FIG. 1, a conventional DVD system 2 comprises the DVD player 4, an input device 6, and a display 8. Audio data may be output to an external audio apparatus 9, often associated with the display 8. The display 8 may be a television, monitor, screen or any other known display. The input device 8 may be an infrared remote control, a mouse, a tablet, a track ball, a keyboard, or the like.

Some of the operational components of a conventional DVD system 2 are best shown in FIG. 2. The conventional DVD system 2 comprises a central processor unit (CPU) 11 for executing programs recorded on a ROM or a RAM, a DVD driving unit 12, a video/audio signal processing unit 13, a caption display unit 14, a memory 15 for storing caption data and sync data, an image overlapping unit 16 for displaying a portion of the caption data on the display 8, an on screen display (OSD) output unit 23, and an input device 6 for inputting user commands. A conventional DVD system 2 has a caption-based display search function, as well as a repeat function.

Operation of the DVD system 2, or DVD reproduction, may be initiated when a user inserts a DVD disc into the DVD driving unit 12, and inputs reproduction instructions using the input device 6. The CPU 11 controls the DVD driving unit 12 to read SPU data (i.e. caption data), as well as video and audio data (i.e. sync data) on the disc. Thereafter, the CPU 11 reconstructs the caption data and the sync data into pairs of caption character strings and pairs of sync data and stores them in the memory 15. Specifically, the CPU 11 sends the data to a decoding chip set (DSC), where the data is decompressed and decoded. Thus, the audio, video, and subtitle data are processed as specific caption character strings.

Once DVD reproduction is initiated, the CPU 11 retrieves the appropriate caption character strings and sync data from the memory 15. A particular scene or image may include a series of caption character strings. The CPU 11 sends appropriate pairs of sync data to the image overlapping unit 16, thereby causing the sync data to be overlapped on the display 8 being reproduced. Subtitle data, or caption character strings, are also retrieved from the memory 15, and displayed on the display 8 by transmitting caption data to the caption display unit 14.

The caption character strings, as well as the sync data, are consecutively stored in the memory 15, and assigned a particular frame number corresponding to each frame. Thus, the CPU 11 is able to determine which frame, and corresponding frame number, is being displayed. In this way, the CPU 11 is able to determine which new caption character strings should be retrieved from the memory 15 based on the frame being displayed on the display 8. The CPU 11 controls the caption displaying unit 14 to delete the previous caption character string, and then retrieves the next appropriate caption character string from the memory 15 once again to be displayed. Thus, the previous caption character string is replaced by a new caption character string.

In order to display the subtitle data in the appropriate position on the display, the subtitle data, or SPU packets, are decoded by a DCS. This DSC contains a series of code, commonly referred to as the SPU address, which allows the SPU packets to be properly displayed on the display 8. The SPU address includes a particular micro-code, which directs the SPU packets to be displayed at a designated position on the display 8 following the decoding process by the DCS. This position is predetermined by the manufacturer, and controlled by the micro-code in the SPU address. In addition, the DCS is able to determine when the SPU packets are to be decoded and displayed based on specific parameters, which are also predetermined by the manufacturer. These parameters (i.e., defining the starting and stopping point for SPU packets) are known as the run length code. Therefore, the positioning of the subtitles on the display 8, as well as the presence of the subtitles on the display 8 with respect to frames, is defined by the micro-code and the run length code.

As images are being displayed, the CPU 11 simultaneously monitors for additional instructions input by the user through the input device 6. For example, the user may operate a display button on the input device, associated with the OSD output unit 23, which causes a menu to be displayed on the display 8. The user may then make additional selections from the displayed menu, as known in the art. Directional keys on an input device 6, along with an enter function actuating the selection, are also known in the art. The CPU 11 is able to determine a designated position for DVD reproduction based on the user's selection. The CPU 11 controls the DVD driving unit 12 to change the reproduction position to the designated position.

Thus, the user is able to provide some instruction as to DVD reproduction, such as selecting a particular scene, or repeating a particular series of frames. However, if a DVD disc contains subtitle data, the user may desire additional information corresponding to the subtitles being displayed. For example, many users use DVD discs as study tools, wherein subtitles are displayed on the display 8. When the user encounters an unknown word in the subtitles, the user is required to inconveniently look up the unknown word in a separate dictionary. As a result, it is difficult for the user to fully understand the situation presented on the display 8, or master the linguistic nuances of a word appearing on the display 8. The user generally must look away from the display 8 and look up the unknown words in the dictionary, thus being distracted from the images being displayed.

### SUMMARY OF THE INVENTION

According to the present invention, a user may select a subtitle word displayed on a display of a DVD system 2, and thereafter receive additional information also displayed on the display 8 that corresponds to the selected word.

A method for achieving the above objective includes the following steps: displaying subtitle data from a DVD on a display; selecting subtitle data to be examined; converting the selected subtitle data into recognizable images; retrieving predetermined information corresponding to the recognizable images; and displaying the predetermined information on the display.

The user selects a caption character string (i.e. a word) from the displayed subtitles by moving a cursor, which is automatically generated at a position of the first word in a displayed sentence, using directional keys associated with an input device 6. The user may move the cursor onto any desired word in the displayed sentence by using the direction keys, and thereafter select the word using the input device 6. After the user makes a word selection, predetermined information that corresponds to the selected word is retrieved from a database, and displayed on the display 8. The user may then resume operation of the DVD when desired.

The predetermined information may be any additional information corresponding to the selected word, and may be stored in a database or memory. The user's selection of the word triggers the display of the corresponding predetermined information, which is retrieved from a database 22 by the CPU 11. The CPU 11 controls the OSD output unit 23, which causes the predetermined information to be displayed on the display 8. The OSD output unit 23 causes the predetermined information to be displayed on an on screen display, as is known in the art.

According to a first embodiment of the present invention, a DVD system has an electronic dictionary function, wherein the predetermined information corresponds to definitions of words displayed in subtitles on the display 8. The user may select an unknown word, while images on the display 8 are paused. Following the user's selection, the definition of the unknown word is displayed on the display 8. Specifically, the claimed method includes the following steps: displaying subtitle data from a DVD on a display; selecting subtitle data to be examined and pausing operation of the DVD during the examination; converting the selected subtitle data into recognizable images; recognizing words formed by the recognizable images, retrieving a definition of a recognized word from a dictionary database, displaying the definition on the display; and resuming DVD operation. The subtitle data may be in SPU format, and the recognizable images may be formatted in ASCII codes. Thus, ASCII codes are retrieved that correspond to subtitle data in SPU format.

According to the first embodiment of the claimed invention, words displayed on a display 8 in the form of subtitles may be defined by looking up the words in an electronic dictionary database 22. The electronic dictionary function may be performed even while the section repetition is made. As a result, a comprehension understanding of words may be learned, as well as an understanding of situations and the linguistic nuance of the words.

In second embodiment of the claimed invention, the user selects the dictionary function by using the input device 8. The input device 8 may have a specific button for initiating the dictionary function, or the dictionary function may be selected from a menu displayed on the display 8 by the OSD output unit 23. The user then spells a word using character or letter keys on the input device 8. The CPU 11 then retrieves the predetermined information corresponding to the input data, which is formatted in ASCII code. Therefore, the CPU 11 retrieves the predetermined information related to the ASCII codes input by the user using the input device 8. In this way, the dictionary function operates as a simply dictionary.

Some elements of a DVD system 2 of the present invention correspond to elements in a conventional DVD system 2, as shown in FIGS. 1 and 2. Corresponding elements explained above will not be described hereafter. A DVD system according to the present invention, and a conventional DVD system, both may include a CPU 11 for executing programs, a DVD driving unit 12, a video/audio signal processing unit 13, a caption display unit 14, a memory 15, an image overlapping unit 16, an OSD output unit 23, and an input device 6.

In addition, the claimed invention provides for a character code converter 21 for converting subtitle data into recognizable images, as well as a database for predetermined information 22, such as an electronic dictionary database. The character code converter 21 converts subtitle data formatted in SPU format to recognizable images formatted in ASCII codes. Predetermined information, corresponding to the ASCII codes, is then retrieved from database 22 and displayed on the display 8 by the OSD output unit 23.

### BRIEF DESCRIPTION OF THE DRAWINGS

FIG. 1 is a drawing of a DVD system including a DVD player, a display, an audio apparatus, and an input device;

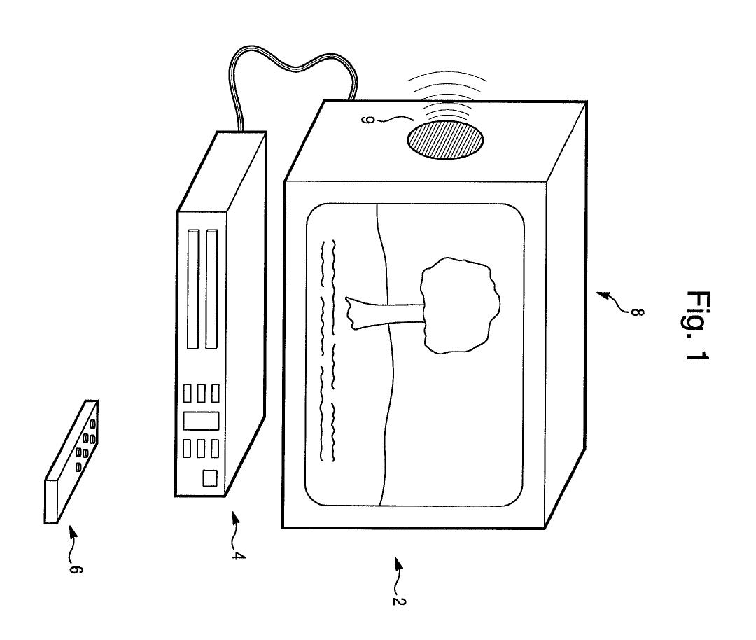

FIG. 2 is a schematic diagram illustrating various components of a conventional DVD system;

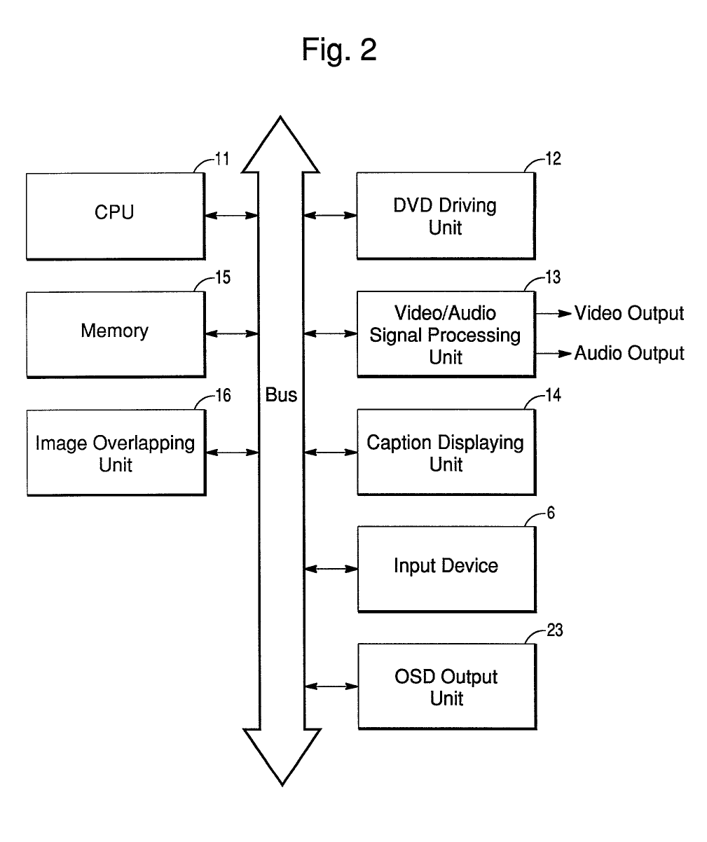

FIG. 3 is a schematic diagram illustrating various components of a DVD system according to the present invention;

FIG. 4 is a flowchart illustrating the steps of selecting a subtitle word displayed on a display by a DVD system and thereafter displaying predetermined information relating to the selected word; and

FIG. 5 is a flowchart illustrating the character recognition algorithm according to the present invention.

### DETAILED DESCRIPTION OF THE INVENTION

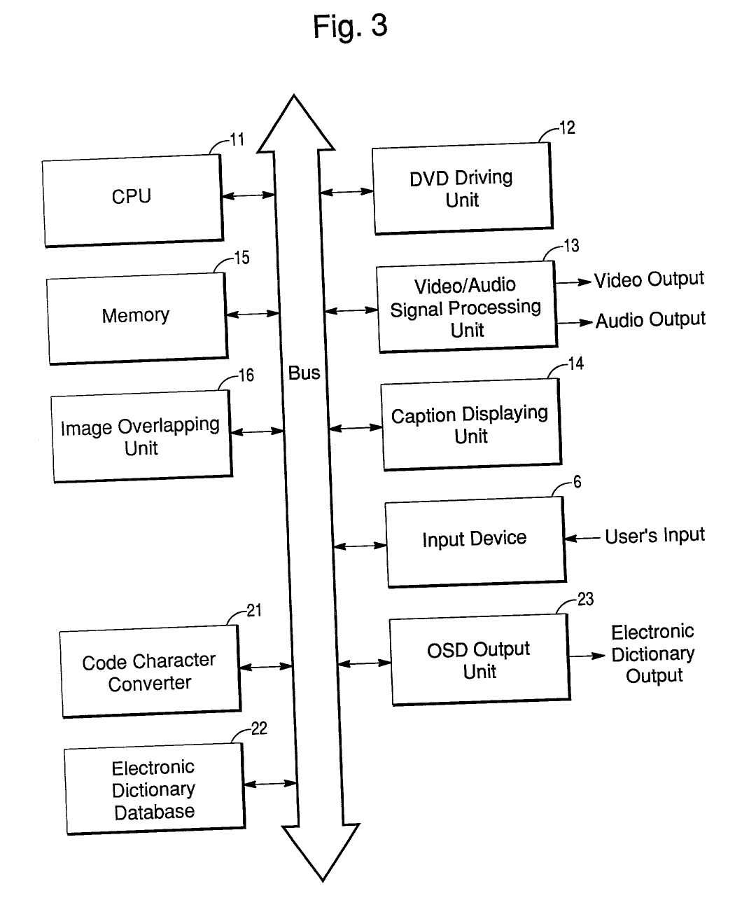

Operational components of a DVD system according to a first embodiment of the claimed invention are best shown in FIG. 3. According to the present invention, the DVD system includes: a CPU 11; a DVD driving unit 12; a video/audio signal processing unit 13; a caption display unit 14; a memory 15; an image overlapping unit 16; an input device 6; a code character converter 21; an electronic dictionary database 22; and an OSD output unit 23. As in the conventional DVD system 2, the DVD system according to the present invention is operably associated with a display 8 and an audio apparatus 9. As noted above, the display 8 may be a television, monitor, screen or any other known display. Similarly, the input device 6 may be an infrared remote control, a mouse, a tablet, a track ball, a keyboard, or the like.

Note that FIG. 3 shows a first embodiment of the present invention, wherein the system includes an electronic dictionary function. However, the claimed invention provides for retrieval of any predetermined information from a database or memory, and is not limited to retrieval of dictionary definitions. For example, selection of a letter, character, word, number or combination thereof displayed in the subtitles on the display may trigger the retrieval of encyclopedic information, footnote information, mathematical equations, or any other desired predetermined information related to the selected subtitle data. Such predetermined information may be stored in a database corresponding to the electronic dictionary database. However, for purposes of explanation, the claimed invention will be explained according to the first embodiment, wherein the predetermined information is dictionary definitions of words displayed in subtitles on the display.

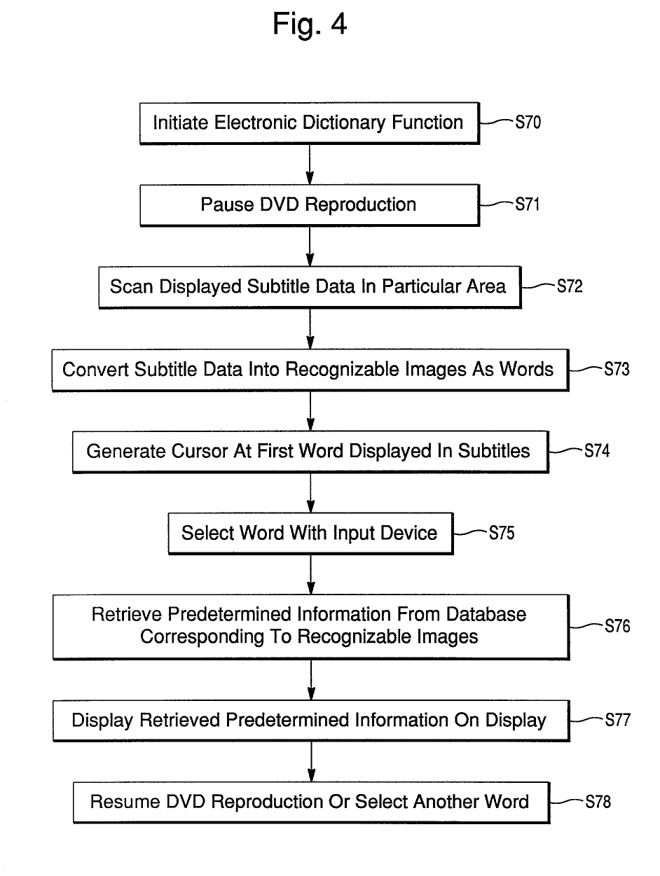

The disclosed invention is designed to work with conventional DVD systems 2. As such, many of the components mentioned above are known in the art, and will not be explained hereafter. As shown in FIG. 4, the user may select the electronic dictionary function using the input device 6 (step S70). Preferably, this selection causes a cursor to be automatically generated at a position of the first word in a displayed sentence of subtitles. However, the selection may also cause a menu to be displayed by the OSD output unit 23, which includes a dictionary function that may then be selected using the input device 6. As explained above, the subtitle data consists of caption character strings, and is preferably formatted in SPU format. The user may select any word from the displayed subtitles by moving the cursor onto the desired word using directional keys and an enter button on the input device 6, as commonly known in the art. The cursor automatically moves from word to word with a sentence or phase being displayed on the display 8.

As best shown in FIG. 4, a user selects a subtitle word displayed on a display by a DVD system, and thereafter additional predetermined information is displayed. Specifically, the user selects the electronic dictionary function using the input device 6 when the DVD system is displaying subtitle data on the display (step S70). Then, the CPU 11 controls the DVD driving unit 12, video/audio signal-processing unit 13, caption display unit 14, and image overlapping unit 16, causing DVD reproduction to be paused (step S71). In addition, audio output to the audio apparatus 9 may is paused.

Next, the CPU 11 scans a particular area on the display 8 that contains the subtitles for subtitle data (step S72). (The scanning process is described below). The particular area containing subtitles is defined by micro-code and run-length code, as explained above. Thus, the CPU 11 scans only those parameters of data defined by the micro-code and run-length code, and identifies the subtitle data therein. The CPU 11 then converts the subtitle data into recognizable images during the scanning process, or character recognition algorithm, explained below (step S73). The subtitle data are preferably formatted in SPU format. The recognizable images are preferably formatted in ASCII codes. The recognizable images may be letters, characters, numbers, or combinations thereof. In the preferred embodiment, the recognizable images are letters, and may be recognized in plurality as words.

After the CPU 11 has deciphered the subtitle data as recognizable images, a cursor is automatically generated at the first word appearing in the subtitles being displayed on the display 8 (step S74). The cursor is controlled by the OSD outputting unit 23, as known in the art. The user may move from word to word using the directional keys on the input device 6, and select a word using the enter button on the input device 6 (step S75). After making a selection, the CPU 11 retrieves predetermined information corresponding to the selected word, which has been deciphered as a recognizable image (step S76). The predetermined information is then displayed on the display 8 (step S77). Thereafter, the user may resume DVD operation, or select another word (step S78). If another word is selected by the user, the predetermined information corresponding to the first word selected is automatically removed from the display, and the new predetermined information corresponding to the next word selected by the user is displayed on the display.

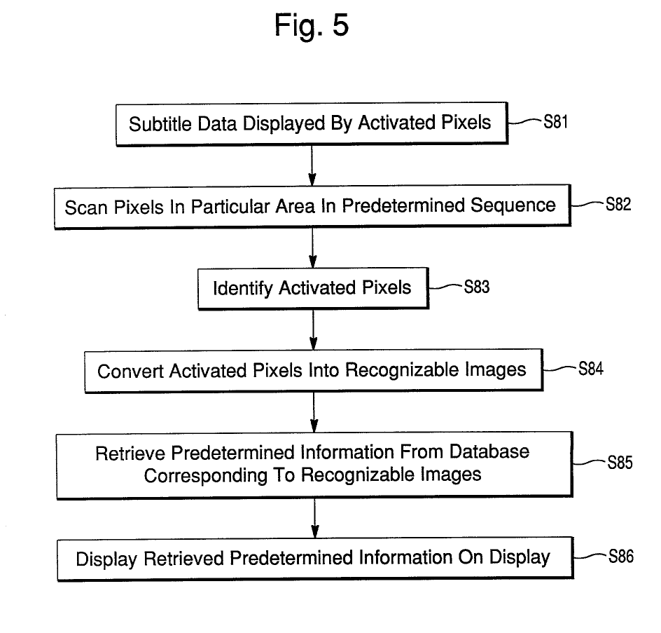

FIG. 5 is a flowchart illustrating the scanning process. In order to identify subtitle data displayed in subtitles on the display 8, the CPU 11 scans data corresponding to a particular area on the display 8. Specifically, the CPU 11 scans only the subtitle data that is defined by the micro-code and run-length code parameters, as noted above. Within these parameters, the subtitle data are bit map images that are displayed on the display 8 by a plurality of activated pixels (step S81). The CPU 11 scans this subtitle data to determine which of the pixels are activated on the display 8. The subtitle data forms a rectangular area defined by run length code on the display 8. This rectangular area is selectively scanned, in a predetermined sequence (step S82). Specifically, the pixel positioned at a corner in the upper left corner of the rectangular area is scanned first. Thereafter, pixels horizontally, vertically, and diagonally adjacent are scanned sequentially and simultaneously from top left to bottom right. In this way, all pixels in the rectangular area are scanned, with the pixel in the upper left corner, relative to the user's view of the display 8, being scanned first, and the pixel at the opposite lower corner being scanned last.

The CPU 11 identifies all activated pixels in the selected rectangular area (step S83), and thereafter initiates a character recognition algorithm. Specifically, the scanned data is compared to preprogrammed recognizable images (i.e. letters defined by a particular font, size, etc., as known in the art). In this way, the CPU 11 identifies and correlates the activated pixels to recognizable images being displayed on the display 8 (step S84). Similarly, a plurality of such letters is further recognized as a word. The recognizable images are preferably formatted in ASCII code, in which case the CPU 11 directs the character code converter 23 to convert the subtitle data from SPU format to ASCII code. After converting the activated pixels into recognizable images, the CPU 11 retrieves predetermined information corresponding to the recognizable images selected by the user (step S85). The predetermined information may be stored in a database, and retrieved therefrom by the CPU 11. This predetermined information is then displayed on the display 8 (step S86).

In a conventional DVD, the specification is primarily composed of a video data region, an audio data region, and an SPU data region. The SPU data region is largely composed of a SPUH (sub-picture unit header), PXD (pixel data), and a SP-DCSQT (subpicture display control sequence table). According to the second embodiment of the present invention, the ASCII code data that corresponds to the PXD are inserted into the SPU data region. The CPU 11 reads this inserted ASCII code data, instead of first reading the SPU data (or subtitle data). Therefore, no subsequent conversion into ASCII code (or other recognizable image) is necessary. Therefore, the CPU 11 initially scans for subtitle data, and may automatically correspond any such subtitle data to respective ASCII codes, which are already inserted into the CPU 11. Thus, the CPU 11 may quickly display predetermined information from the database corresponding to the ASCII codes.

As noted above, certain aspects of the claimed invention have been explained according to a first embodiment having an electronic dictionary function. However, it will be apparent to one of ordinary skill in art that various modifications and variations can be made in construction or configuration of the present invention without departing from the scope or spirit of the invention. The character recognition algorithm may be applied to numerous applications and functions, given any additional predetermined information may be stored in the database. Thus, it is intended that the present invention cover the medications and variations of the invention, provided they come within the scope of the following claims and their equivalents.

What is claimed is:

1. A DVD reproducing apparatus including a CPU for executing programs, a DVD driving unit, a video/audio signal processing unit, a caption displaying unit, an image overlapping unit and an input device, comprising:
a character code converter for converting SPU data into ASCII codes;
an electronic dictionary database (DB) in which data of a foreign language dictionary are stored; and
an OSD output unit for controlling output of search results obtained by searching said electronic dictionary.

2. A DVD reproducing method having an electronic dictionary function, comprising the steps of
pausing images on a screen by a user selecting said electronic dictionary function;
reading caption character strings according to the respective words by a CPU;
converting SPU data of said read words into ASCII codes;
when said user selects a word, fetching data corresponding to said ASCII codes of said selected word from an electronic dictionary database by the CPU; and
outputting said fetched data.

3. The DVD reproducing method as claimed in claim 2, wherein said step of selecting said word further comprises a step of selecting said word by moving said cursor, which is generated at a position of a first word in a sentence, into a word that said user wants to select by way of said user's operation of a direction key.

4. The DVD reproducing method as claimed in claim 2, wherein said step of outputting said fetched data comprises a step of outputting said data onto a position where subtitles are not displayed in a still screen using an OSD so that said fetched data can not be overlapped with said subtitles.

5. The DVD reproducing method as claimed in any one of claims 1-2, wherein said SPU data in said DVD includes said ASCII codes corresponding to the respective characters.

6. A method of selecting a subtitle word displayed on a display by a digital versatile disc (DVD) system and thereafter displaying additional information corresponding to the selected subtitle word, comprising the steps of:
displaying subtitle data from a DVD on a display;
selecting subtitle data to be examined;
converting the selected subtitle data into recognizable images;
retrieving predetermined information related to the recognizable images; and
displaying the predetermined information on the display.

7. The method of claim 6, including the step of selecting subtitle data with an input device.

8. The method of claim 7, including the step of providing as the input device an apparatus selected from the group consisting of an infrared remote control, a mouse, a tablet, a track ball, and a keyboard.

9. The method of claim 8, including the step of selecting subtitle data by operation of directional keys associated with the input device.

10. The method of claim 6, comprising the further steps of:
providing a central processor unit; and
converting with the central processor unit the selected subtitle data into recognizable images.

11. The method of claim 10, including the steps of:
displaying the subtitle data in bit map images;
converting the bit map images into the recognizable images, the recognizable images being selected from the group consisting of numbers, letters, characters, and combinations thereof; and
recognizing words formed by the recognizable images.

12. The method of claim 11, including the steps of:
displaying the subtitle data as a plurality of activated pixels;
determining which of the pixels are activated; and
retrieving the recognizable images corresponding to the activated pixels.

13. The method of claim 12, including the step of determining which of the pixels are activated by scanning in a predetermined sequence.

14. The method of claim 13, including the step of determining which of the pixels in the predetermined sequence are activated by selectively scanning each one of the pixels.

15. The method of claim 14, including the step of determining which of the pixels are activated by selectively scanning the pixels in a rectangular area displayed on the display.

16. The method of claim 15, including the steps of:
initiating the selective scanning with a particular pixel positioned at a corner of the rectangular area;
consecutively scanning adjacent pixels relative to the particular pixel within the rectangular area, so that all pixels within the rectangular area are sequentially scanned.

17. The method of claim 16, including the step of recognizing a particular letter displayed by the activated pixels.

18. The method of claim 16, including the step of recognizing a particular character displayed by the activated pixels.

19. The method of claim 16, including the step of recognizing a particular number displayed by the activated pixels.

20. The method of claim 17, including the step of recognizing a word formed by a plurality of letters displayed by the activated pixels.

21. The method of claim 20, including the step of recognizing a particular font of the letter displayed by the activated pixels.

22. The method of claim 21, including the step of recognizing a size of the letter displayed by the activated pixels.

23. The method of claim 10, including the steps of:
providing the subtitle data in SPU format; and
displaying the subtitle data in SPU format from a DVD on a display.

24. The method of claim 23, comprising the further steps of:
providing a database of recognizable images formatted in ASCII codes; and
retrieving the ASCII codes corresponding to the subtitle data in SPU format.

25. The method of claim 10, including the step of providing a database for storing predetermined information.

26. The method of claim 25, including the step of displaying predetermined information that is dictionary definitions corresponding to the selected subtitle data.

27. A method of selecting a subtitle word displayed on a display by a digital versatile disc (DVD) system and thereafter displaying additional information corresponding to the selected subtitle word, comprising the steps of:
displaying subtitle data from a DVD on a display as bit map images, the subtitle data displayed on the display according to predetermined run length code and predetermined micro-code;
selecting subtitle data to be examined, and pausing operation of the DVD during the examination;
converting the bit map images into ASCII codes;
retrieving predetermined information from a database that corresponds to the ASCII codes;
displaying the predetermined information on the display; and
resuming operation of the DVD.

28. The method of claim 27, including the step of selecting subtitle data with an input device.

29. The method of claim 28, including the step of providing as the input device an apparatus selected from the group consisting of an infrared remote control, a mouse, a tablet, a track ball, and a keyboard.

30. The method of claim 29, including the step of selecting subtitle data by operation of directional keys associated with the input device.

31. The method of claim 27, comprising the further steps of:
providing a central processor unit;
converting with the central processor unit the bit map images into ASCII codes, the ASCII codes being selected from the group consisting of numbers, letters, characters, and combinations thereof; and
recognizing with the central processor unit words formed by the ASCII codes.

32. The method of claim 31, including the steps of:
displaying the bit map images by a plurality of activated pixels;
determining which of the pixels are activated; and
retrieving the ASCII codes corresponding to the activated pixels.

33. The method of claim 32, including the step of determining which of the pixels are activated by scanning in a predetermined sequence.

34. The method of claim 33, including the step of determining which of the pixels in the predetermined sequence are activated by selectively scanning each one of the pixels.

35. The method of claim 34, including the step of determining which of the pixels are activated by selectively scanning the pixels in a rectangular area displayed on the display.

36. The method of claim 35, including the steps of:
initiating the selective scanning with a particular pixel positioned at a corner of the rectangular area;
consecutively scanning horizontally adjacent pixels relative to the particular pixel within the rectangular area;
consecutively scanning vertically adjacent pixels relative to the particular pixel within the rectangular area; and
consecutively scanning diagonally adjacent pixels relative to the particular pixel so that all pixels within the rectangular area are scanned.

37. The method of claim 36, including the step of recognizing a particular letter displayed by the activated pixels.

38. The method of claim 36, including the step of recognizing a particular character displayed by the activated pixels.

39. The method of claim 36, including the step of recognizing a particular number displayed by the activated pixels.

40. The method of claim 37, including the step of recognizing a word formed by a plurality of letters displayed by the activated pixels.

41. The method of claim 40, including the step of recognizing a particular font of the letter displayed by the activated pixels.

42. The method of claim 41, including the step of recognizing a size of the letter displayed by the activated pixels.

43. The method of claim 34, including the steps of:
providing the bit map images in SPU format;
displaying the bit map images in SPU format from a DVD on a display; and
retrieving the ASCII codes corresponding to the bit map images in SPU format.

44. The method of claim 43, including the step of displaying predetermined information that is dictionary definitions corresponding to the selected subtitle data.

45. A method of selecting a subtitle word displayed on a display by a digital versatile disc (DVD) system and thereafter displaying a definition of the selected subtitle word, comprising the steps of:
displaying subtitle data from a DVD on a display;
selecting subtitle data to be examined and pausing operation of the DVD during the examination;
converting the selected subtitle data into recognizable images, the recognizable images being selected from the group consisting of letters, characters, and combinations thereof;
recognizing words formed by the recognizable images;
retrieving a definition of a recognized word from a dictionary database;
displaying the definition on the display; and
resuming operation of the DVD.

46. The method of claim 45, including the step of selecting subtitle data with an input device.

47. The method of claim 46, including the step of providing as the input device an apparatus selected from the group consisting of an infrared remote control, a mouse, a tablet, a track ball, and a keyboard.

48. The method of claim 47, including the step of selecting subtitle data by operation of directional keys associated with the input device.

49. The method of claim 48, comprising the further steps of:
providing a central processor unit; and
converting with the central processor unit the selected subtitle data into recognizable images.

50. The method of claim 49, including the steps of:
displaying the subtitle data in bit map images;
converting the bit map images into the recognizable images.

51. The method of claim 50, including the steps of:
displaying the subtitle data as a plurality of activated pixels;
determining which of the pixels are activated; and
retrieving the recognizable images corresponding to the activated pixels.

52. The method of claim 51, including the step of determining which of the pixels are activated by scanning in a predetermined sequence.

53. The method of claim 52, including the step of determining which of the pixels in the predetermined sequence are activated by selectively scanning each one of the pixels.

54. The method of claim 53, including the step of determining which of the pixels are activated by selectively scanning the pixels in a rectangular area displayed on the display.

55. The method of claim 54, including the steps of:
initiating the selective scanning with a particular pixel positioned at a corner of the rectangular area,
consecutively scanning adjacent pixels relative to the particular pixel within the rectangular area, so that all pixels within the rectangular area are sequentially scanned.

56. The method of claim 55, including the step of recognizing a particular letter displayed by the activated pixels.

57. The method of claim 55, including the step of recognizing a particular character displayed by the activated pixels.

58. The method of claim 56, including the step of recognizing a word formed by a plurality of letters displayed by the activated pixels.

59. The method of claim 58, including the step of recognizing a particular font of the letter displayed by the activated pixels.

60. The method of claim 59, including the step of recognizing a size of the letter displayed by the activated pixels.

61. The method of claim 45, including the steps of:
providing the subtitle data in SPU format; and
displaying the subtitle data in SPU format from a DVD on a display.

62. The method of claim 61, comprising the further steps of:
providing a database of recognizable images formatted in ASCII codes; and
retrieving the ASCII codes corresponding to the subtitle data in SPU format.

63. A method of selecting a subtitle word displayed on a display by a digital versatile disc (DVD) system and thereafter displaying additional information corresponding to the selected subtitle word, comprising the steps of:
providing a central processor unit;
inserting in the central processor unit ASCII codes corresponding to subtitle data;
displaying subtitle data from a DVD on a display;
selecting subtitle data to be examined;
recognizing by the central processor unit the corresponding ASCII codes of the selected subtitle data;
retrieving predetermined information related to the ASCII codes; and
displaying the predetermined information on the display.

64. The method of claim 63, including the step of selecting subtitle data with an input device.

65. The method of claim 64, including the step of providing as the input device an apparatus selected from the group consisting of an infrared remote control, a mouse, a tablet, a track ball, and a keyboard.

66. The method of claim 65, including the step of selecting subtitle data by operation of directional keys associated with the input device.

67. The method of claim 66, including the step of providing a database for storing the predetermined information.

68. The method of claim 67, including the step of displaying predetermined information that is dictionary definitions corresponding to the selected subtitle data.
